(19) United States
(12) Patent Application Publication
(10) Pub. No.: US 2014/0368127 A1
(43) Pub. Date: Dec. 18, 2014

(54) FIELD CONFIGURABLE LED DRIVERS FOR LIGHTING

(71) Applicant: Jonathan Hollander, Petach Tikva (IL)

(72) Inventor: Jonathan Hollander, Petach Tikva (IL)

(73) Assignee: METROLIGHT LTD., Netanya (IL)

(21) Appl. No.: 14/470,959

(22) Filed: Aug. 28, 2014

Related U.S. Application Data
(63) Continuation-in-part of application No. 11/910,920, filed on May 5, 2008, now Pat. No. 8,849,428.
(60) Provisional application No. 60/670,273, filed on Apr. 12, 2005.

(51) Int. Cl. H05B 37/02

(52) U.S. Cl. CPC H05B 37/0254; H05B 37/0272
USPC 315/294

(57) ABSTRACT

Computerized methods are provided herein for remotely configuring a driver operable to power an illumination system, over a wide area network. A configuration request is received by a configuration server over the wide area network to configure the driver. The configuration request is from a configuration client operatively attached over the wide area network to the configuration server. The driver is configured by transmitting instructions from the configuration server to the configuration client to produce a driver configuration. A data base attached to the configuration server is updated based on the driver configuration.

### CROSS REFERENCE TO RELATED APPLICATIONS

The present application is a continuation-in-part application of U.S. patent application Ser. No. 11/910,920 filed 08 Oct. 2007, which is a national phase application of international patent application PCTIL06000471 filed 11 Apr. 2006 which claims priority from US provisional application 60/670,273 filed 12 Apr. 2005 by the present inventor.

### BACKGROUND

1. Technical Field

The present invention relates to current sources for illumination, and, more particularly, to a method of configuring current sources/drivers for illumination systems including light emitting diode (LED)s and current source LED drivers for use in different illumination system configurations.

2. Description of Related Art

Although an efficient light source, the use of HID lamp technology may have several disadvantages. HID lamps require several minutes to warm up. When the HID lamp is initially cool, an ignition voltage of 3000-5000 volts for instance is typically required to ignite the HID lamp. A re-ignition for the same lamp when the lamp is still hot, may require up to 20,000 volts for re-ignition to occur. The re-ignition when the lamp is still hot may also require a different frequency or phase characteristic for the ignition voltage to avoid risk of blowing up the HID lamp. Lamps and ballasts with hot re-strike capability are much more expensive then ballasts and lamps without hot re-strike capability. Under a drop of mains voltage, when hot re-strike is not used or unavailable, HID lamps remain off for five to ten minutes while they cool down before re-ignition. While HID lamps are in the process of cooling down, other lighting may be used which supplies sufficient light just after the mains voltage comes back on. Quartz-halogen lamps are often used for emergency lighting which are lit while the HID lamps are cooling down and waiting for re-ignition. The quartz-halogen lamps require different wiring and fixtures from the HID lamps. Further, some HID lamps, such as mercury halide lamps may pose an environmental hazard, in that the bulb materials include mercury. This mercury has to be safely disposed of when the metal halide bulb is no longer usable in fixture 100.

Thus, there may be an advantage and a need to replace HID lighting with LED lighting. LEDs are becoming more widely used in consumer lighting applications. In consumer applications, one or more LED dies (or chips) are mounted within a LED package or on a LED module, which may make up part of a low power LED lighting fixture, typically less than 50 Watts which includes one or more power supplies to power the LEDs. Various implementations of LED lighting fixtures are becoming available in the marketplace to fill a wide range of applications. LEDs offer improved light efficiency, a longer lifetime, lower energy consumption and reduced maintenance costs, as compared to HID light sources.

Consequently, a supplier of lamps, e.g. HID and/or LED lamps and current source drivers to power them may need to stock hundreds of different current sources, each current source with its own part number for supporting all the different types of lamps and all the available power ratings. Moreover, the current source may include many features built in such as dimming control, depth of dimming level, time to dimming from start, color/color temperature and input voltage range.

There is thus a need for, and it would be highly advantageous to have a method of configuring a current source, e.g. LED current source driver and/or an HID electronic ballast to support as required different types of lamps, e.g. light emitting diodes and/or HID lamps of different power ratings and other parameters. By stocking a single part number, a considerable savings in logistics costs is achieved.

### BRIEF SUMMARY

Various computerized methods are provided herein for remotely configuring a driver operable to power an illumination system, over a wide area network. A configuration request is received by a configuration server over the wide area network to configure the driver. The configuration request is from a configuration client operatively attached over the wide area network to the configuration server. The driver is configured by transmitting instructions from the configuration server to the configuration client to produce a driver configuration. A data base attached to the configuration server is updated based on the driver configuration. One or more operative parameters of the driver may be configurable to operate at least one type of a plurality of lamp types selected from the group consisting of: a gas discharge lamp and multiple interconnected light emitting diodes (LEDs). The driver may be attached to the configuration mechanism solely during the configuration and subsequent to the configuration, the configuration mechanism may be detached from the driver. A service policy for the driver may be modified based on the update of the database and/or the service policy may be based on the driver configuration. The configuration client may request to configure the driver, by transmitting from the client computer the configuration request to the configuration server and the instructions are received from the configuration server in response to the configuration request. Prior to the configuration of the driver, an identifying parameter of the driver may be verified.

Payment may be tendered for the configuration and an invoice may be provided for the payment. The operative parameter may be one or more of: ignition voltage, ignition duration, ignition frequency, warm-up current, output power, output current, color, color temperature, dimming level, automatic dimming control, automatic restart, temperature range, input voltage range, and/or lifetime. The configuration mechanism may include a communications mechanism for communicating between the client computer and the driver. The configuration may include storing the operative parameter in memory included in the driver. Various drivers may be configured according to the methods disclosed herein. Various non-transitory computer readable media may be encoded with processing instructions for causing a processor to execute the methods disclosed herein.

The foregoing and/or other aspects will become apparent from the following detailed description when considered in conjunction with the accompanying drawing figures.

### BRIEF DESCRIPTION OF THE DRAWINGS

The invention is herein described, by way of example only, with reference to the accompanying drawings, wherein:

FIG. 1 is a system and flow diagram, according to an embodiment of the present invention.

FIG. 2a-d are illustrations of layouts of a computer display, according to an embodiment of the present invention.

FIG. 3a is a simplified schematic drawing of a ballast undergoing configuration according to an embodiment of the present invention, and “daisy chaining” of like ballasts.

FIG. 3b shows a circuit diagram of a LED circuit, according to an aspect of the present invention.

### DETAILED DESCRIPTION

Reference will now be made in detail to features of the present invention, examples of which are illustrated in the accompanying drawings, wherein like reference numerals refer to the like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings.

The invention is capable of other features or of being practiced or carried out in various ways. Also, it is to be understood that the phraseology and terminology employed herein is for the purpose of description and should not be regarded as limiting.

By way of introduction, various embodiments of the present invention are directed to configuring a ballast/current source/driver for use with different power ratings and/or different lamp types. The system/method may use a microprocessor controlled electronic ballast for powering a high intensity discharge lamp and/or the system/method may use a LED current source/driver to power an LED lamp with multiple interconnected LEDs. The electronic ballast may include a microprocessor to support a large range of output powers, e.g. 20-1000 W, and programmable parameters (or software versions) which support different types of lamps and optional features including a dimming option, and dimming delay. According to an embodiment of the present invention, the manufacturer supplies hardware and/or software to a local supplier, reseller, customer or distributor for configuring the electronic ballast/LED current source/driver. Typically, the distributor requires for configuring the ballast/LED current source/driver a computer with a connection to a communications port of the ballast/LED current source/driver.

The distributor may optionally use a bar code reader to verify the part number and/or serial number of the electronic ballast/LED current source/driver under configuration and a label printer to print labels for marking the new part number subsequent to configuring.

The method may enable customers or distributors to electronically configure parameters of the electronic ballast/LEDcurrent source/driver through the communications port without opening the electronic ballast/LEDcurrent source/driver unit. Furthermore, the electronic ballast/LEDcurrent source/driver may be modified in the distributor's warehouse or at the customer site with a communications connection between the microcontroller of the electronic ballast/LEDcurrent source/driver to the computer using a wired or wireless connection. The reconfiguration is preferably performed by the distributor upon requesting configuration instructions over a wide area network from the manufacturer of the field configurable electronic ballast/LEDcurrent source/driver, and upon tendering payment, the distributor configures or reconfigures the electronic ballast/LEDcurrent source/driver.

The manufacturer may configure the electronic ballast/LEDcurrent source/driver prior to shipping and typically the customer or distributor pays the manufacturer of the electronic ballast/LEDcurrent source/driver for configuring or reconfiguring the electronic ballast/LEDcurrent source/driver.

According to yet another embodiment of the present invention, the electronic ballast/LEDcurrent source/driver is re-configured even when the electronic ballast/LEDcurrent source/driver is already installed in the customer facilities.

Further the configuration mechanism may be of any such mechanisms known in the art and includes a computer and hardware/software required to attach to and program the microprocessor controlling the ballast. Typically, the microprocessor controlling the electronic ballast/LEDcurrent source/driver includes or is attached to non-volatile memory, such as but not limited to PROM, EPROM, EEPROM, Flash memory and optical memory. The configuration mechanism rewrites the software programming the microprocessor and/or parameters stored in the non-volatile memory of the electronic ballast/LEDcurrent source/driver.

It should be further noted that the principles of the present invention are equally applicable across the full range of electronic ballasts including “low frequency ballasts operating at tens of Hertz below the acoustic resonance of discharge lamps as well as “high frequency” operating at hundreds of Hertz typically above the acoustic resonance of gas discharge lamps. While the discussion herein is directed toward application of the present invention to gas discharge and LED lamps, the principles of the present invention may be readily adapted for use with fluorescent lamps as well.

The principles and operation of a system and method of employing electronic ballasts/LEDcurrent sources/drivers in the field, according to the present invention, may be better understood with reference to the drawings and the accompanying description.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

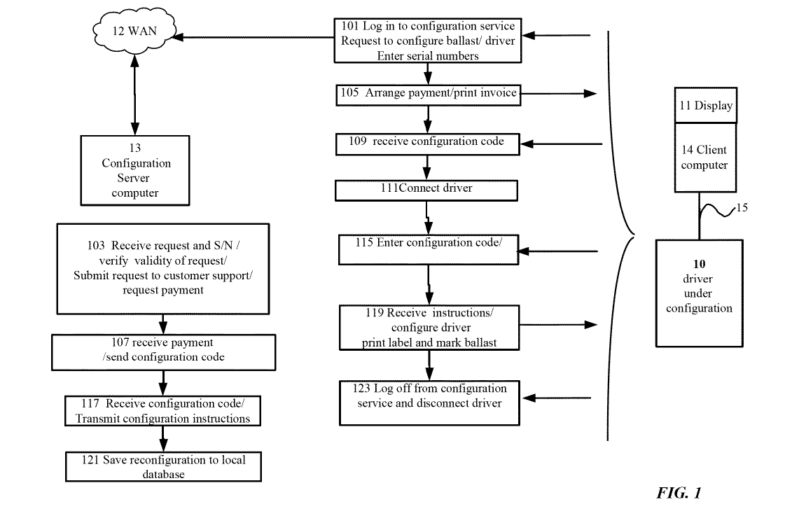

Referring now to the drawings, reference is now made to FIG. 1, a simplified block diagram and flow diagram of an embodiment of the present invention. A driver 10 under configuration or reconfiguration is connected to a client computer 14 through a communications interface 15. Driver 10 may be an electronic ballast for powering an HID lamp or a LED current source/driver for powering a lamp of interconnected light emitting diodes (LEDs). Client computer 14 may have a connection over a wide area network (WAN) 12 to a configuration server 13, typically owned by the manufacturer e.g. Metrolight Ltd. of driver 10. Configuration server 13 provides the configuration service, according to an embodiment of the present invention.

Using client computer 14, customer enters customer support section of the manufacturer of driver 10 and finds a “Request for driver parameter change form” available on-line through wide area network 12, e.g. at Internet site www.metrolight.net. The following steps are typically performed according to the numerical order of the numerical references to the steps.

101 Customer logs in the the configuration service. Customer enters the configuration or re-configuration request for the required changes to operative parameters of driver 10. Customer typically enters a serial and/or part number either manually, or for instance the serial/part number is read automatically using a bar code scanner or other automatic mechanism.

103 At server 13, validity of the request is received and verified (step 103). An example of verifying validity is for instance if the requested parameter, e.g. power output, is within the rating of driver 10. After receiving the configuration request, a reply electronic mail message, is preferably sent automatically, which indicates that the configuration request has been received. The reply message is sent for instance, to a specified electronic mail address with a notification that the request will be handled within a specific time period, e.g. within 24 hours. The form content is submitted to Customer Support, for instance by electronic mail. Optionally, configuration server 13 saves the request to a local database. Open verifying the validity of the request, payment for configuration is requested (step 103) from the customer. Alternatively, validity of the request is verified at client 14 using an agent or otherwise software installed on client 14.

105 Customer arranges payment and prints invoice/receipt as required.

107 The configuration service receives payment and sends a configuration code associated with the serial number and/or part number of driver 10 under configuration.

109 Client computer receives the configuration code. A user of client computer 14, connects (step 111) driver under configuration using interface 15. The user logs into the configuration service (if not currently logged in) and enters, or automatically transfers the configuration code, or alternatively a hash or derivative of the received configuration code based on the serial/part number of driver 10.

117 Upon receiving the configuration code, configuration server 13 transmits instructions which either programs driver 10 directly or enable programming to occur by software previously installed on client 14.

119 Client 14 receives instructions which are transferred directly to driver 10 for configuration or client 14 performs configuration based on the instructions received from configuration server 13.

121 At server 13, configuration is stored in a local database, and a service policy for driver 10 is updated accordingly.

123 User at client 14 logs off from configuration service and disconnects driver 10.

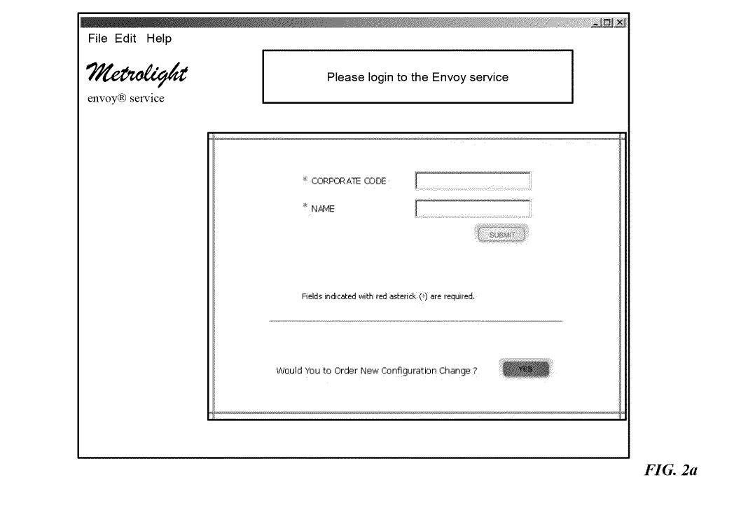

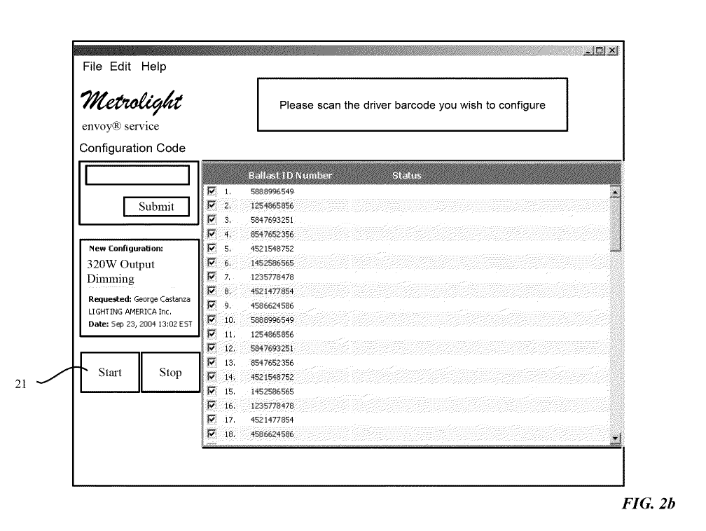

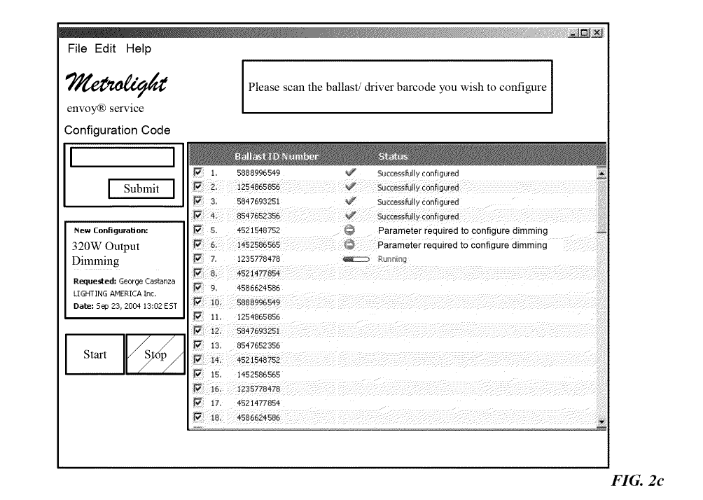

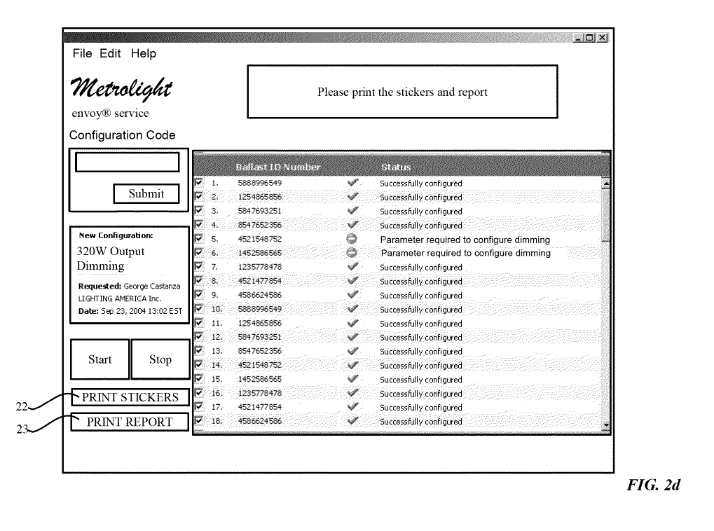

Reference is now made to FIGS. 2a-2d which illustrate layouts of display screen 11 of client computer 14, in an example of the present invention. A logistics person

George Castanza at the warehouse of Lighting America Inc. logs in (step 101) to configuration server 13. FIG. 2a illustrates a log-in window for ordering a change in driver 10 configuration. George scans (using for instance an optical handheld barcode scanner) the barcode labels of drivers 10 prior to configuring (step 119). As the barcodes of drivers 10 are scanned, corresponding serial numbers appear on display screen 14 as illustrated in FIG. 2b. After barcodes are scanned, George selects one hundred drivers 10 are to to be configured with new parameters 320 W output power with a dimming feature. George then presses a Start Button 21 which requests (step 101) from configuration server 13 to perform the configuration and serial numbers of the drivers to be configured are transmitted to configuration server 13. George then typically arranges payment (step 105) if applicable, and a configuration code is generated; the configuration code associated with drivers 10 to be configured is transmitted (step 115) by client computer 14 and received (step 117) by configuration server 13, instructions for configuration of drivers 10 are transmitted (step 117) to client computer 14, and the configuration is executed (step 119). During execution (step 119), success or failure to configure is displayed on display screen 11 under the column labeled “status” in FIG. 2c. When the batch of drivers 10 have been configured (step 119) (or failed to configure) display 11 shows virtual buttons “print labels” 22 which when selected generates labels for labelling the drivers subsequent to configuring (step 119) (or labels marking rejects) and “print report” 23 which prints a report of the configuration process for quality management.

During driver configuration (step 119), if a scanned serial number S/N does not equal the programmed S/N stored in memory within driver 10 then driver 10 will not be configured. According to an embodiment of the present invention, a status update to server 13 will typically be sent for each driver 10 before continuing with the next driver. The status report will include the following options:
Successfully configured,
Failure to configure-S/N not correct,
driver fault—i.e. driver has not been fully configured, changes have been partially executed to one or more parameters, and current configuration of driver 10 is not defined.

When a batch of drivers 10 is fully configured a message will be displayed on display 11: “New label must be printed and attached to driver”. Preferably, the user is not allowed to proceed with configuration procedure (step 119) without printing a label for driver 10 after configuration. Alternatively, in order to print labels, the user will use print labels button 22, and labels will be printed for all of newly configured drivers 10.

Referring back to FIG. 1, in step 121, configuration information of each driver 10 is saved in a data base by server 13. Saved configuration information is typically used to update a service policy of driver 10 upon configuration. For instance, a driver 10, originally configured and operated at 200 W in reconfigured at 320 W, according to an embodiment of the present invention. Using the data base, a service policy for driver 10 is updated, for instance a money back warrantee policy which expires after five years prior to reconfiguration is changed to expire after three years subsequent to reconfiguration.

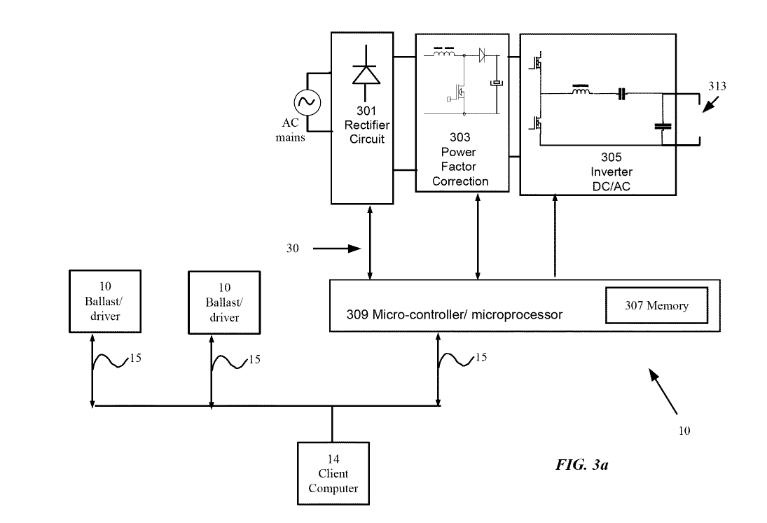

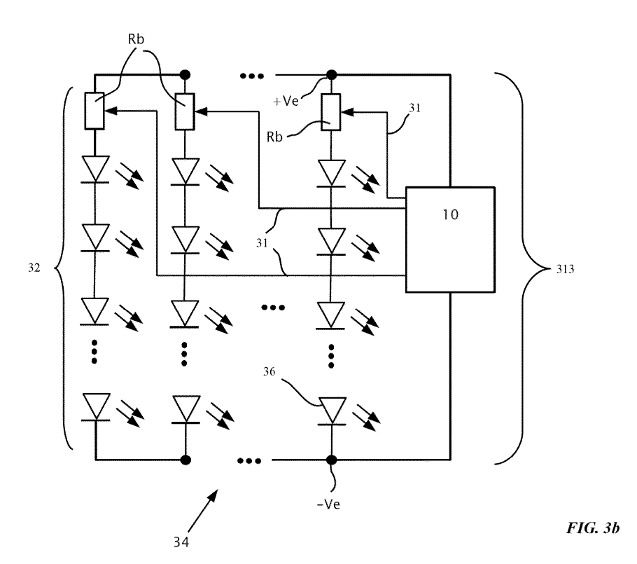

Reference is now made to FIG. 3a which illustrates a simplified block diagram of a configurable electronic ballast 10, being configured according to an embodiment of the present invention. Configurable ballast 10 is includes a rectifier circuit 301 which rectifies the alternating current of the power line to direct pulsating current. The pulsating direct current is input to a circuit 303 that performs “power factor correction” (PFC). “Power factor” is a figure of merit indicating to what extent the current and the voltage are in phase. PFC 303 also filters the current to reasonably constant direct current. PFC circuit 303 is sometimes followed by a “buck converter” (not shown in FIG. 3a) providing a current source and performing a DC-DC step down conversion. The “buck converter” is followed by a full-wave or half-wave bridge 305 operating as an “inverter” outputting a for instance a square wave at output 313 to the discharge lamp. Microprocessor/microcontroller 309 monitors and controls 30 are used to control all the functions of the ballast circuit, including frequency of switching at gates of FET in PFC circuit 303 and inverter circuit 305, voltage levels, output power levels and features such as dimming capability of ballast 10. The communications interface 15 used in ballast 10 is preferably a simple two or three wire serial bus (e.g. UART, I²C or SPI) integrated with the microprocessor controlling ballast 10. The two or three pins of the microprocessor required for communications during configuration (step 119) are preferably reused for other purposes during ballast 10 operation, i.e. controlling power to a discharge lamp, thereby reducing cost of the microprocessor and communications related components. Also shown in FIG. 3 is “daisy chaining” of serial bus interface 15 allowing many ballasts 10 to be configured (step 119) as a batch process. In other embodiments of the present invention, other wired interfaces 15 may be used including RS-232 or EIA-485, Universal Serial Bus (USB) or Ethernet IEEE 802.3. Alternatively, the connection to the ballast may be achieved with wireless communications, using a wireless RF transceiver attached to the ballast. Examples of wireless communications include Ethernet (IEEE 802.11), GPRS, and Bluetooth.

Reference is now also made to FIG. 3b which shows a circuit diagram of a LED circuit 34, according to an aspect of the present invention. Multiple LEDs 36 are connected in series to form a series string 32. Also connected in series in serial string 32 is a controllable variable impedance, e.g. variable resistor Rb, a variable current limiter or a linear regulator which may receive a control signal 31 to control current through string 32. Control signal 31 may be an analog signal or a digital signal which is appropriate for the controllable variable resistor Rb, the variable current limiter or the linear regulator. The DC output 313 (+Ve, −Ve) of ballast 10 or another power source of DC such a constant current source may be applied to multiple strings 32 connected in parallel as shown. Output 313 may be wired in series with the multiple LEDs 36 (which are connected in series) or in parallel across multiple LEDs 36 connected in series. Serial string 32 may be connected in parallel with other strings 32 which are also connected in parallel across ballast 10 output 313. The polarity of output 313 on +Ve and −Ve is such that each string 32 is forward biased. Variable resistor Rb in one or more strings 32 may receive control signal 31 from ballast 10 which may be configured determine the resistance of string 32 or otherwise limit or set the current flowing in string 32. Any number of series parallel or parallel series connections may be made in each string 32 and between strings 32 in a series or parallel fashion. The LEDs 36, the number of LEDs 36 and the current supplied to a circuit 32 when operating the LEDs 36 are typically selected so that the circuit 32 is operable at a minimum electrical power rating comparable to that of a discharge lamp of between 50 Watts and 200 Watts or more up to 400-500 Watts. The two or three pins of micro-controller 309 required for communications during configuration (step 119) may be reused for other purposes during ballast 10 operation, i.e. controlling power to a discharge lamp and/ or controlling power (via control signals 31) to LED circuit 34.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, flash disk, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a phone or Personal Digital Assistant “PDA”) where internal modules (such as a memory and processor) work together to perform operations on electronic data. While any computer system may be mobile, the term “mobile computer system” especially includes laptop computers, netbook computers, cellular telephones, smart phones, wireless telephones, personal digital assistants, portable computers with touch sensitive screens and the like.

In this description and in the following claims, a “network” is defined as any architecture where two or more computer systems may exchange data. The term “network” may include wide area network, Internet local area network, Intranet, wireless networks such as “Wi-fi”, virtual private networks, mobile access network using access point name (APN) and Internet. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general-purpose computer system or special-purpose computer system to perform a certain function or group of functions.

The term “server” as used herein refers to a computer system including a processor, data storage and a network adapter generally configured to provide a service over the computer network. A computer system which receives a service provided by the server may be known as a “client” computer system.

The term “contextual” as used herein refers to text and/or audio speech which includes one or more previously defined keywords or portions of the one or more keywords.

The term “audio” or “audio speech” as used herein refers to sound and/or an analog electrical signal transduced from the sound.

The term “data” as used herein refers to a processed analogue signal, the processing including analogue to digital conversion into digital information accessible to a computer system.

The term “high power” as used herein refers to an electrical power rating of at least 50 Watts.

The term “driver” as used herein refers to a device which provided a controlled, limited or constant current, which may be a power supply or other current controlling device known in the art intended to provide power to a lamp.

The terms “distributor”, reseller and “customer” are used herein interchangeably and refers to either a wholesaler or a final consumer of ballast products and/or employees thereof and/or another acting on behalf of the distributor.

The terms “configuration and “reconfiguration” are used herein interchangeably.

The term “wide area network” as used herein is a computer and/or communications networking technology used to transmit data over long distances, and between different local area networks, metropolitan area networks and other localised computer networking architectures, to span regions, countries, or even the world.

The articles “a”, “an” is used herein, such as “a LED”, “a driver” have the meaning of “one or more” that is “one or more LEDs” or “one or more drivers”.

The present application is gender neutral and personal pronouns ‘he’ and ‘she’ are used herein interchangeably.

Although selected features of the present invention have been shown and described, it is to be understood the present invention is not limited to the described features. Instead, it is to be appreciated that changes may be made to these features without departing from the principles and spirit of the invention, the scope of which is defined by the claims and the equivalents thereof.

While the invention has been described with respect to a limited number of embodiments, it will be appreciated that many variations, modifications and other applications of the invention may be made.

What is claimed is:

1. A computerized method for remotely configuring a driver operable to power an illumination system, over a wide area network, the method comprising:
receiving a configuration request by a configuration server over the wide area network to configure the driver wherein the configuration request is from a configuration client operatively attached over the wide area network to said configuration server;
configuring said driver by transmitting instructions from the configuration server to the configuration client to produce a driver configuration; and
updating a data base attached to the configuration server based on said driver configuration.

2. The computerized method according to claim 1, wherein at least one operative parameter of the driver is configurable to operate at least one type of a plurality of lamp types selected from the group consisting of: a gas discharge lamp and a plurality of interconnected light emitting diodes (LEDs).

3. The computerized method according to claim 1, wherein the driver is attached to said configuration mechanism solely during the configuration, further comprising:
subsequent to the configuration, detaching the configuration mechanism from the driver.

4. The computerized method according to claim 1, wherein a service policy for said driver is modified based on said updating.

5. The computerized method, according to claim 1, wherein a service policy for said driver is based on said driver configuration.

6. The computerized method according to claim 1 further comprising:
requesting by the configuration client to configure said driver, thereby transmitting from the client computer said configuration request to said configuration server; and
receiving said instructions from said configuration server; wherein said instructions are in response to said configuration request.

7. The computerized method according to claim 1, further comprising the step of, prior to said configuring: verifying an identifying parameter of said driver.

8. The computerized method, according to claim 1, further comprising the steps of: tendering payment for the configured driver; and providing an invoice for said payment.

9. The computerized method, according to claim 1, wherein said at least one operative parameter is selected from the group consisting of: ignition voltage, ignition duration, ignition frequency, warm-up current, output power, output current, color, color temperature, dimming level, automatic dimming control, automatic restart, temperature range, input voltage range, and lifetime.

10. The computerized method according to claim 1, further comprising the step of, prior to said configuring: verifying an identifying parameter of said driver.

11. The computerized method, according to claim 1, wherein said configuration mechanism includes a communications mechanism for communicating between said client computer and said driver.

12. The computerized method, according to claim 1, wherein said configuring includes storing said at least one operative parameter in memory included in said driver.

13. A driver configured according to the method of claim 1.

14. A non-transitory computer readable medium encoded with processing instructions for causing a processor to execute the method of claim 1.
